(19) United States
(12) Patent Application Publication
(10) Pub. No.: US 2014/0175307 A1
(43) Pub. Date: Jun. 26, 2014

(54) DEVICE FOR CURING COATINGS OR PLASTIC LINERS ON INTERNAL WALL OF ELONGATED HOLLOW SPACES

(71) Applicant: Thomas Arnold, Bessenbach (DE)

(72) Inventor: Thomas Arnold, Bessenbach (DE)

(73) Assignee: HERAEUS NOBLELIGHT GmbH, Hanau (DE)

(21) Appl. No.: 14/236,717

(22) PCT Filed: Jul. 4, 2012
(86) PCT No.: PCT/EP2012/002801

§ 371 Date: Feb. 3, 2014

(30) Foreign Application Priority Data
Aug. 4, 2011 (DE) 10 2011 109 386.2

(51) Int. Cl. H05B 3/00

(52) U.S. Cl. CPC H05B 3/0057
USPC 250/492.1

(57) ABSTRACT

A known device for curing of coatings or plastic liners on the internal wall of elongated hollow spaces includes a UV lamp having a bulb for emission of optical radiation. Based on this known device, it is proposed to provide a device for the curing of coatings or plastic liners on the internal wall of elongated hollow spaces that has a long service life and has a reduced attendant risk of damage to health and materials. The proposed device has an optical filter element to reduce the emission of an ultraviolet fraction of the optical radiation. The optical filter element has a spectral transmission of at least 80% cm⁻¹in a wavelength range of 400 nm to 450 nm, and has an edge wavelength in the range of 350 nm to 380 nm.

### CROSS-REFERENCE TO RELATED APPLICATIONS

This application is a Section 371 of International Application No. PCT/EP2012/002801, filed Jul. 4, 2012, which was published in the German language on Feb. 7, 2013, under International Publication No. WO 2013/017190 A1 and the disclosure of which is incorporated herein by reference.

### BACKGROUND OF THE INVENTION

The present invention relates to a device for the curing of coatings or plastic liners on the internal wall of elongated hollow spaces, the device comprising a UV lamp having a bulb for emission of optical radiation.

For renovation of pipe and canal systems it has been customary for many years to use renovation procedures that allow the functional capability of restoring the pipe and canal systems and, as a result, prolonging their service life. Aside from coating procedures for coating the internal wall of the hollow spaces, the renovation procedures used in this context also include liners, which are fiber-reinforced composite materials consisting of resin-soaked textile materials, for example glass fibers.

The coating or resin is cured in the pipe or canal system, and this can be effected, for example, by thermal means by introducing hot water or water vapor or by optical means through the use of ultraviolet radiation. Liners for thermal curing need to be stored refrigerated and even then show only limited stability. The use of optical procedures is advantageous due to the better storage features, and these methods are energy-efficient and gentle on the environment.

A device of this type for the irradiation of internal walls of elongated hollow spaces, in particular for the curing of photo-curable plastic laminates is known from Canadian published patent application CA 2,337,239 A1. The device, which can be moved within the hollow space, is configured to have UV lamps arranged in a lamp mount and comprising a pressure spring on the opposite side. A threaded spindle drive facilitates variable adaptation of the distance of the lamp to the internal wall of the synthetic resin laminate to be cured.

Another irradiation source for irradiation of internal walls of elongated hollow spaces with UV radiation is proposed in German utility model DE 298 20 521 U1. The radiation source comprises, on the ends, running units, which are spring-activated, arranged in the cross-sectional plane of the pipe, connected to each other, and each comprise a quartz glass tube positioned in axial orientation. The inside of the quartz glass tube has a lamp arranged in it, which serves for irradiation of the interior of the tube.

German published patent application DE 101 45 648 A1 discloses an irradiation device for the irradiation of objects, in which a gas discharge lamp having a gallium-containing filling gas is provided as the radiation source.

Moreover, the teaching of Swiss Patent CH 328 598 A is an ultraviolet filter consisting of quartz glass which is used as wall of gas discharge tubes. The purpose of the ultraviolet filter is to selectively eliminate certain ranges of the UV spectrum.

Pure quartz glass is transparent to UV radiation in the wavelength range up into the UVC-VUV range and thus is a preferable lamp material for UV light sources.

When the lamps are used in devices for the curing of coatings or plastic liners, they emit not only the working radiation, but also a fraction of ultraviolet radiation of shorter wavelength that can lead to health damage or cause aging of components lying in the vicinity. This applies specifically to components made of plastic.

### BRIEF SUMMARY OF THE INVENTION

The invention is therefore based on the object to provide a device for the curing of coatings or plastic liners on the internal wall of elongated hollow spaces, wherein the device has a long service life and is associated with a reduced risk of damage to health or materials.

The object is met according to the invention based on a pipe and canal renovation device of the type specified above, wherein the bulb contains a gallium-containing filling gas, wherein an optical filter element is provided in order to reduce the emission of an ultraviolet fraction of the optical radiation, and wherein the filter element has a spectral transmission of at least 80% cm⁻¹ in a wavelength range of 400 nm to 450 nm and has an edge wavelength in the range of 350 nm to 380 nm.

In previous pipe and canal renovation systems, pure quartz glass, which is transparent for UV radiation in the wavelength range up into the UVC-VUV range, was used as a lamp material for the UV lamp.

Proceeding from this background, the invention proposes two modifications of which one relates to the emission spectrum of the radiation produced in the bulb, and the other relates to the adaptation of the emission spectrum to the conditions prevailing during the intended use of the device.

Doping the filling gas with gallium produces a characteristic emission spectrum. The radiation thus produced shows pronounced intensity peaks in a wavelength range that covers the working range of the device for the curing of coatings or plastic liners on the internal wall of elongated hollow spaces.

The preferred working range of wavelengths of the radiation used here is between 400 nm and 450 nm. It has been evident that the emitted radiation of a wavelength below 400 nm and above 450 nm is not obligatory for curing of coatings or plastic liners.

However, the gallium-containing filling gas emits outside the working range also, specifically in the ultraviolet wavelength range.

In order to adapt the spectrum thus generated to the working range, the fraction of UV radiation is reduced or eliminated through the use of the optical filter element. The radiation that is reduced or eliminated through the optical filter element comprises all or part of the UV wavelength range, such that health damage due to emitted UV radiation is prevented and components lying in the vicinity of the device can have a long service life.

For this purpose, the optical filter element comprises an edge wavelength in the range of 350 nm to 380 nm. The edge wavelength corresponds to the wavelength at which the spectral internal transmission factor is equal to half of the maximal difference between the internal transmission factors of stopband and passband. The spectral internal transmission factor is an abstraction of the reflection losses and is defined as the ratio of the outgoing spectral flow of radiation to the incoming flow of radiation.

The optical filter element is designed as a coating or as a doping of a substrate. In the simplest case, the substrate is the bulb of the UV lamp.

A preferred modification provides the radiation source to comprise at least one main emission line in the wavelength range of 400 nm to 450 nm at a wavelength that is at least 10 nm and at most 50 nm above the edge wavelength.

The filter element eliminates or reduces the fractions of UV radiation in the emission spectrum that are not needed for curing the coating or liner. Consequently, however, only a narrow wavelength range remains as useful working radiation. Therefore, it is particularly important for the intended use of the device to have a main emission in the wavelength range.

Having the wavelength of the main emission being immediately adjacent to the edge wavelength of the optical filter element results in any undesired fractions of UV radiation in the main emission not being absorbed. On the other hand, due to the wavelength being at least 10 nm above the edge wavelength, the emission of the main emission line is not affected excessively. If the wavelength of the main emission line is more than 50 nm above the edge wavelength, there is, on the one hand, a danger that the fraction of undesired short-wave ultraviolet radiation is not minimized effectively. On the other hand, if the edge wavelength is high, the working wavelength range still available for a main emission line is narrow, such that there is a risk that sufficient irradiation intensity cannot be attained.

A preferred variant of the device provides the optical filter element to be manufactured from aluminum-doped quartz glass.

An optical filter element made of aluminum-doped quartz glass is chemically and thermally stable and cannot be damaged, which is in contrast to a coating.

It has proven expedient for the optical filter element to comprise an aluminum content in the range of 10 ppm by weight to 20 ppm by weight.

An optical filter element comprising an aluminum content of less than 10 ppm by weight leads to a low reduction of the undesired fractions of UV radiation. An optical filter element having an aluminum content above 20 ppm by weight considerably reduces the spectral transmission in the working range.

An alternative preferred variant provides the optical filter element to be manufactured from cerium-doped quartz glass.

An optical filter element made of cerium-doped quartz glass is chemically and thermally stable and cannot be damaged, which is in contrast to a coating.

An advantageous refinement provides the optical filter element to be a quartz glass hollow cylinder having a UV lamp arranged in it.

Arranging the UV lamp inside a quartz glass hollow cylinder protects the UV lamp from mechanical influences and contamination. A quartz glass hollow cylinder is easy to clean and to replace, and a filter element in the form of a quartz glass hollow cylinder is easy and inexpensive to manufacture. The pipe shape assures largely isotropic absorption of the UV radiation emitted by the UV lamp in all directions of space. The external diameter of the quartz glass hollow cylinder can be adjusted to match the internal geometry of the canal or pipe.

Another preferred refinement provides the quartz glass hollow cylinder to surround the UV lamp in a gas-tight manner and to comprise a gas-tight seal for conducting current for electrical contacting of the UV lamp.

Arranging the UV lamp inside a quartz glass hollow cylinder protects the UV lamp from mechanical influences. An overall compact design is facilitated by having the quartz glass hollow cylinder surround the UV lamp in a gas-tight manner and by having it comprise a gas-tight seal for conducting current for electrical contacting of the UV lamp. The quartz glass hollow cylinder can comprise one or more gas-tight seals. It can be designed to be socketed on one end or two ends. The quartz glass cylinder can be filled with a noble gas or comprise a vacuum.

In the simplest case, the optical filter element is the bulb of the UV lamp.

A filter element that doubles as the bulb of the UV lamp is inexpensive to manufacture and enables the design of the device to be particularly compact.

Alternatively or in addition, it has proven to be expedient to design the optical filter element as a coating on the quartz glass hollow cylinder and/or the bulb.

In this context, the coating is provided on the outside and/or inside of the quartz glass hollow cylinder and/or bulb. Coatings are easy to apply and their properties can be adjusted variably. A suitable coating can, for example, be a multi-layered interference reflection filter made of titanium dioxide and silicon dioxide.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown. In the drawings:

FIG. 1 is a longitudinal schematic view showing an embodiment of a lamp unit of the device according to the invention having an optical filter element in the form of a quartz glass hollow cylinder; and

FIG. 2 is a graph showing a spectral intensity distribution of the UV lamp having a schematic transmission curve of a doped quartz glass drawn into it.

### DETAILED DESCRIPTION OF THE INVENTION

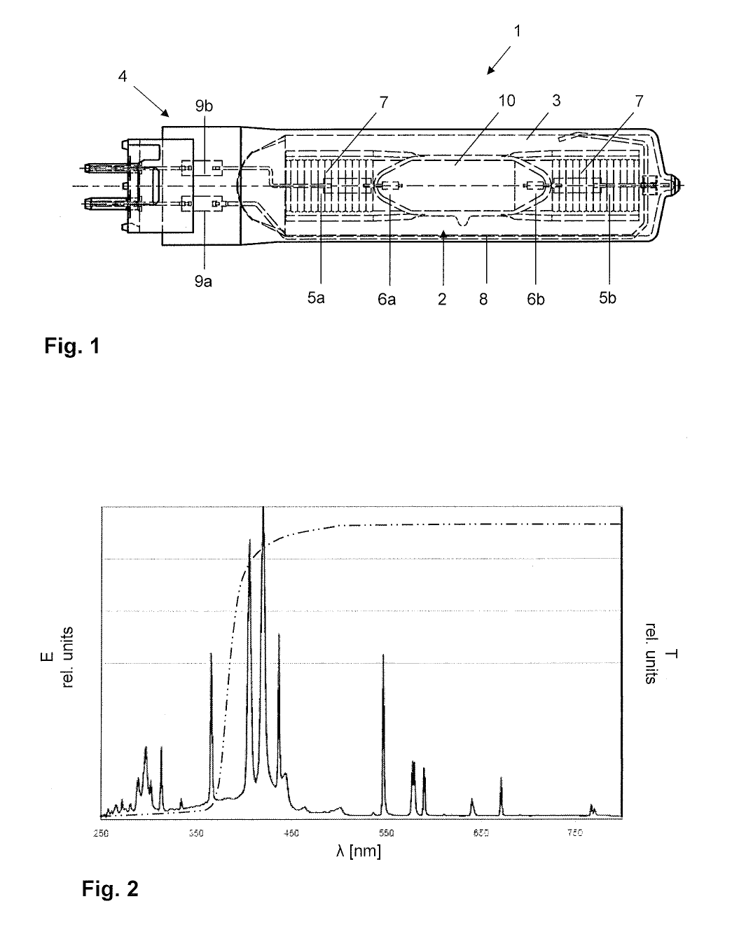

The device according to the invention for the curing of coatings or plastic liners on the internal wall of elongated hollow spaces comprises a lamp unit of the type shown in FIG. 1, to the entirety of which reference number 1 is assigned. The lamp unit 1 comprises a UV lamp for emission of optical radiation, a gas-tight quartz glass hollow cylinder 3, and a gas-tight seal 4. The UV lamp is a medium pressure mercury lamp 2 having a power rating of 600 W. Otherwise, lamps having a power rating of 100 W to 2,000 W are provided to cure coatings or plastic liners. The medium pressure mercury lamp 2 comprises a gas-tight bulb 10 that is filled with mercury, noble gas, and gallium. One bushing 5a, 5b each for electrical contacting of electrodes 6a, 6b is provided in the two gas-tight seals 7 of the medium pressure mercury lamp 2.

### EXAMPLE 1

The medium pressure mercury lamp 2 is surrounded by a quartz glass hollow cylinder 3 made from a quartz glass quality supplied by Heraeus Quarzglas GmbH & Co. KG, Hanau, Germany under the trade designation “HLQ382.” The quartz glass contains 0.6 ppm lithium, 0.3 ppm sodium, 0.4 ppm potassium, 0.05 ppm magnesium, 0.5 ppm calcium, 0.1 ppm iron, less than 0.05 ppm copper, less than 0.05 ppm manganese, and 15 ppm aluminum. The quartz glass hollow cylinder 3 serves as a filter element in the scope of the present invention.

### EXAMPLE 2

In an alternative embodiment, the quartz glass hollow cylinder 3 is made from a cerium-doped quartz glass, for example like the one supplied by Heraeus Quarzglas GmbH & Co. KG, Hanau, Germany, under the trade designations “M 382 Plus” or “M382 S Plus.” In this case, the quartz glass contains as chemical impurities, 1 ppm lithium, 1 ppm sodium, 0.8 or 0.1 ppm potassium, 0.1 ppm magnesium, 1.0 or 0.1 ppm calcium, 0.8 or 0.2 ppm iron, 0.1 ppm copper, 0.1 ppm chromium, 0.05 ppm manganese, and 20 or 10 ppm aluminum. In addition, the quartz glass is cerium-doped.

The quartz glass hollow cylinder 3 surrounds the medium pressure mercury lamp 2 in a gas-tight manner. The hollow space 8 between the quartz glass hollow cylinder 3 and the medium pressure mercury lamp 2 is filled by the noble gas, argon. Two current bushings 9a, 9b for electrical contacting of the medium pressure mercury lamp 2 are provided to extend through the gas-tight seal 4 of the quartz glass hollow cylinder 3.

FIG. 2 shows a spectral intensity distribution of the medium pressure mercury lamp 2 in the wavelength range from 250 to 750 nm. The wavelength range of the working radiation for curing coatings or plastic liners is from 400 to 450 nm. The medium pressure mercury lamp 2 emits radiation outside and inside the working range. In particular, the spectrum comprises two main emission lines at approx. 410 nm and 420 nm.

In order to minimize the short-wave fraction of the emission (E) outside of the working wavelength range, the quartz glass hollow cylinder 3 is used as a filter glass. The transmission curve (T: transmission) of the radiation source mentioned above is schematically drawn into the spectral intensity distribution of the quartz glass hollow cylinder 3 according to Example 1. The spectral transmission of the quartz glass (without scattering and reflection losses at the surfaces) within the working wavelength range is more than 90% cm⁻¹. It is evident, though, that wavelengths below approx. 400 nm are absorbed to an increasing degree by the optical filter element and are thus removed by the filter.

The edge wavelength of the filter is at approximately 380 nm. The two main emission lines at approx. 410 nm and 420 nm mentioned above are touched by the filter effect of the quartz glass hollow cylinder 3, but are not eliminated.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

1.-10. (canceled)

11. A device for curing of coatings or plastic liners on an internal wall of elongated hollow spaces, the device comprising a UV lamp having a bulb for emission of optical radiation, wherein the bulb contains a gallium-containing filling gas, and an optical filter element to reduce emission of an ultraviolet fraction of the optical radiation, wherein the optical filter element has a spectral transmission of at least 80% cm⁻¹ in a wavelength range of 400 nm to 450 nm and has an edge wavelength in a range of 350 nm to 380 nm.

12. The device according to claim 11, wherein the UV lamp comprises at least one main emission line in the wavelength range of 400 nm to 450 nm at a wavelength that is at least 10 nm and at most 50 nm above the edge wavelength.

13. The device according to claim 11, wherein the optical filter element is made of aluminum-doped quartz glass.

14. The device according to claim 13, wherein the aluminum content is in a range of 10 ppm by weight to 20 ppm by weight of the aluminum-doped quartz glass.

15. The device according to claim 11, wherein the optical filter element is made of cerium-doped quartz glass.

16. The device according to claim 11, wherein the optical filter element is a quartz glass hollow cylinder having a UV lamp arranged in it.

17. The device according to claim 16, wherein the quartz glass hollow cylinder surrounds the UV lamp in a gas-tight manner and comprises a gas-tight seal to conduct current for electrical contacting of the UV lamp.

18. The device according to claim 11, wherein the optical filter element comprises the bulb.

19. The device according to claim 11, wherein the optical filter element comprises a coating on the bulb.

20. The device according to claim 16, wherein the optical filter element comprises a coating on the quartz glass hollow cylinder or on the quartz glass hollow cylinder and the bulb.
